(19) United States
(12) Patent Application Publication
(10) Pub. No.: US 2018/0156187 A1
(43) Pub. Date: Jun. 7, 2018

(54) MOUNTING FOR A TIDAL TURBINE

(71) Applicant: TIDAL ENERGY LIMITED, Cardiff (GB)

(72) Inventors: Clive ADSHEAD, Cardiff (GB); Peter BROMLEY, Cardiff (GB); Paul ELKINGTON, Cardiff (GB)

(21) Appl. No.: 15/555,753

(22) PCT Filed: Feb. 12, 2016
(86) PCT No.: PCT/GB2016/050334

§ 371 Date: Sep. 5, 2017

(30) Foreign Application Priority Data
Mar. 5, 2015 (GB) 1503774.0

(51) Int. Cl. F03B 13/26

(52) U.S. Cl. CPC F03B 13/264; F05B 2250/292; F05B 2240/97; F05B 2230/608

(57) ABSTRACT

A marine turbine and tower combination in which the turbine is mountable on the tower, The turbine has a co-operating member to interact with the tower to enable the turbine to be mounted on the tower in a pre-determined alignment. In one arrangement, the support tower comprises a substantially horizontal thruster plate mounted on top of the tower. The thruster has a central aperture to receive a downwardly directed stud on the turbine the thruster plate providing lateral support for the turbine. The stud has a vertical reaction interface around a lower part of the stud which is supported vertically by a reaction ring mounted on the tower.

Tidal turbines are an increasingly attractive option for power generation. They have two distinct advantages over other so-called alternative energy sources, they are mounted below water and do not create the same environmental concerns as wind turbines and the tide itself is very predictable and, if the turbine is located in the right place, capable of generating large quantities of electricity reliably.

However, tidal turbines do have issues of their own, particularly if maintenance is required; frequently divers had to be employed to carry out any inspections required and repair necessary which is both costly and inconvenient. Various solutions have been proposed involving uncoupling the turbine and its surrounding nacelle from its mounting on a sea bed, raising the turbine and nacelle with a marine crane and transporting it to shore. Most solutions allow the turbine to be placed in one of two or more fixed positions with respect to the mounting (the so called turbine yaw) and a mechanism provided to move the turbine from one yaw portion to another in response to changes in the flow of the tide. Such devices are clearly cumbersome in use and require continual monitoring. More recently GB 2437533 B (SWANTURBINES LIMITED AT AL) 31 Oct. 2007 proposed a marine turbine and support for fixing to the bed of a body of water, the turbine and support comprising complementary male and female engaging portions such that when the turbine is lowered onto the support, the male and female portions contact one another. This provides an operational engagement there between. The male engaging portion comprises a first part for interfacing with the female engaging portion and a second part rotatable mounted relative to the first part such that the turbine rotates relative to the support during operation of the turbine to enable alignment of the turbine with a fluid flow, and where the first part of the male engaging portion is arranged to be located in the female engaging portion in a plurality of rotational orientations.

However, the proposals of GB2437533 have two distinct issues.

Firstly the power take off from the turbines is either taken separately in a cable away from the mount, or has a fixed plug into the male part described. In the first approach the cable is liable to be damaged as it is not well protected and will in any event tend to twist with yawing of the turbine. If the power connection is to the male part through the mount, the cable is protected but the twisting is even more severe with a likelihood of failure of the power take off, which will require divers to repair, negating the benefits of the demountable turbine.

Secondly the female socket part is likely to be difficult to manufacture and itself require maintenance.

According to the present invention in a marine turbine and tower combination in which the turbine is mountable on the tower, the turbine has a co-operating member to interact with co-operating members on the tower to enable the turbine to be mounted on the tower in a pre-determined alignment.

Advantageously the predetermined alignment enables the turbine to connect to electrical cables in the tower.

In one embodiment the co-operating member on the tower is a downwardly directed stud and the co-operating members on the tower comprise a substantially horizontal thruster plate mounted on top of the tower having a central aperture and a vertical reaction ring beneath the thruster plate, wherein when the turbine is mounted on the tower the stud extends through the aperture in the horizontal thruster plate, the stud being supported laterally by the thruster plate, and vertically by the reaction ring interacting with the stud.

Alignment is further aided with capture cylinder to help to locate the stud in the reaction ring.

It has been found that the best arrangements to ensure accurate alignment and good lateral support for the turbine is achieved when the horizontal thruster plate is has four parallel sides and the external profile of stud where it is within the horizontal thruster plate is correspondingly shaped so that the stud is a tight fit in the horizontal thruster plate when the turbine is in position on the tower. Ideally the four parallel sides form a square. Optionally, to enable efficient load transfer the corners of adjacent sides are cut-off.

In the arrangement of the previous paragraph the lower portion of the stud is best circular in cross section as is the aperture of the reaction ring; this makes for easy location of the stud in the reaction ring.

Other features of the invention are set out in the claims and in the following description.

In order that the invention might be more fully understood, one example will now be described with reference to the accompanying drawings, in which:

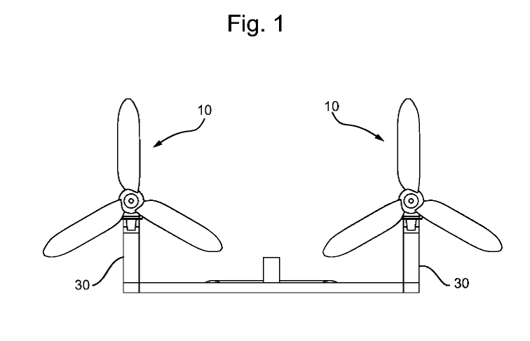

FIG. 1 show a general structure with multiple tidal turbines;

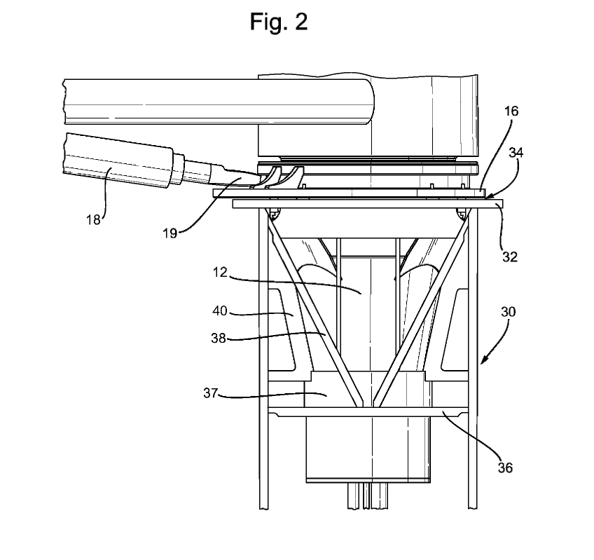

FIG. 2 show a side view of the general mating arrangements between a turbine and a tower in the present invention;

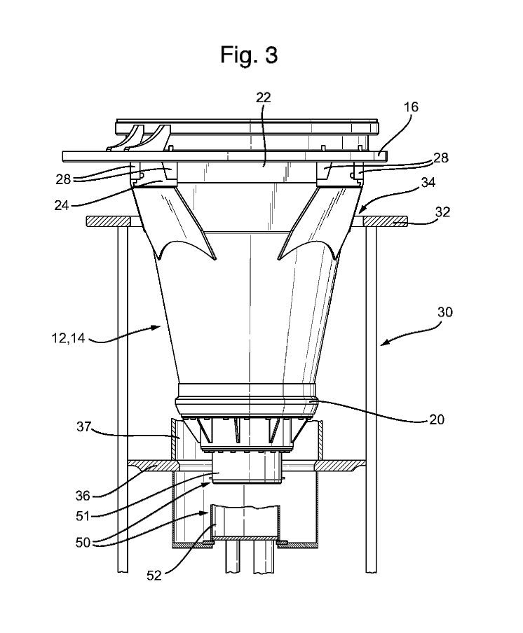

FIG. 3 show a section view of the interaction of the pintle support frame with the tower shown in FIG. 2;

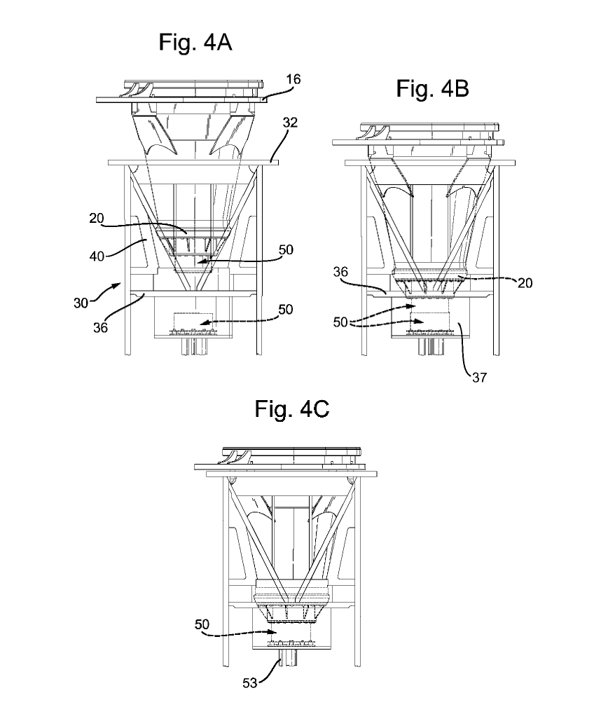

FIG. 4 shows the steps toward final mating of the turbine with the tower; and

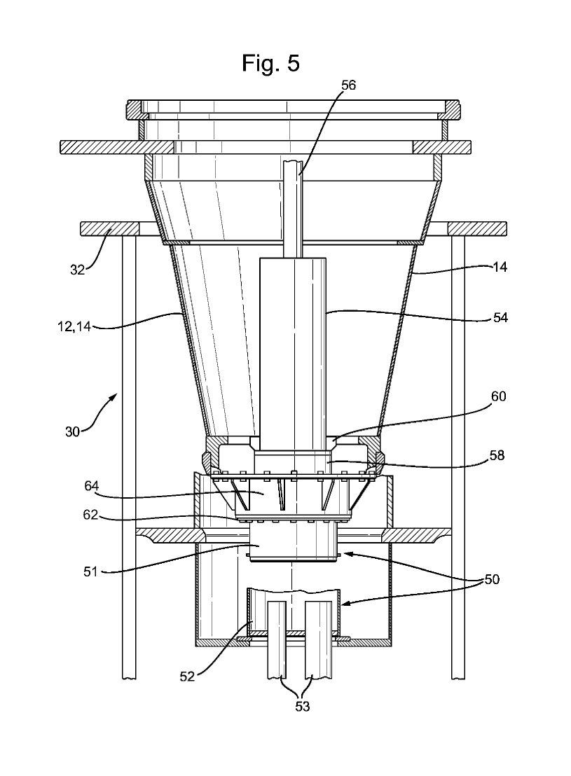

FIG. 5 shows a side view of the electrical interfaces with the slip ring head removed.

In FIG. 1, a tidal turbine 10 is mounted on a tower 30. Power is transmitted from each tower 30 to onshore by means of appropriate cable. Power connection between each tidal turbine 10 and the power take off cables leading on shore is part of this invention and described below, for especially with reference to FIG. 5.

Each tower 30, which may be an individual tower or be part of a larger assembly on a frame, is lowered to the sea floor with or without a tidal turbine 10 attached using standard offshore lifting tackle connected to one or more eyes on the tower or a frame on which it is mounted. If a tower 30 is lowered without a turbine 10 mounted, the turbine 10 can be lowered subsequently and fitted to the tower 30 separately as described below.

Before this invention, if maintenance was required on one of the turbines the whole structure tower included had to be lifted again from the sea bed using lifting tackle connected to the eyes or divers sent to carry out the repair; either option was very expensive, with the present invention a single turbine needing repair can be lifted from its tower individually without disturbing the tower or any other turbine in the vicinity.

In FIG. 2 the general arrangements of a tidal turbine 10 and tower 30 are shown. The turbine 10 has a downwardly extending stud 12, which in the illustrated example is a pintle support frame 14. The pintle support frame 14 extends downwards around the pintle. A flange 16 around the pintle support frame 14 has yaw actuation drives 18, mounted thereon at attachment points 19 to adjust the yaw of the turbine.

A substantially horizontal thruster plate 32 is mounted on top of the tower 30 having a central aperture 34, the pintle support frame 14 extending through the horizontal thruster plate 32 and supported laterally thereby. Bearings (not shown) within the pintle support frame 14 also provide lateral support to the pintle.

A vertical reaction interface 20 (see FIG. 3) around the lower part of the pintle support frame 14 is supported vertically by a reaction ring 36 mounted on the tower 30. Within the pintle support frame 14 is a slip ring containing the turbine take off cable, (discussed in relation to FIG. 5) on which is mounted an underwater mateable connector 50 to enable power from the turbine to be transmitted to a fixed cable 52 in the tower.

To add strength to the structure and to distribute load cross bearers 38 link the reaction ring 36 to the horizontal thruster plate 32. When fully engaged with the tower the reaction ring 36 substantially supports the weight of the turbine vertically and the horizontal reaction ring 32 substantially supports it laterally.

Overturning moments are reacted horizontally between upper horizontal reaction ring 32 and the lower reaction ring 36.

Also visible in FIG. 2 are vertical guide vanes 40 which engage the side of the pintle support frame 14 as it is located into the reaction ring 36 which provide further assistance in locating the turbine.

FIG. 3 show the pintle support frame 14 in more detail. As shown in FIG. 3 the tidal turbine is about 300 mm above its final position on the tower with electrical connections unmade. The pintle support frame 14 immediately below flange 16 has four parallel sides 22 forming a square, having cut-offs 24 at what would otherwise be the corners of the square created when viewed in cross section. The purpose of the cut-offs is for efficient load transfer, but they have no impact on the concept of the invention The four parallel sides 22 and cut-offs 24 taper inwards as one travels down the pintle support frame. The horizontal thruster plate 32 shown in FIG. 2 and an aperture of the same cross section to the pintle support frame below flange 16, to receive the pintle support frame. Load transfer blocks 28 are mounted below flange 16 to ensure that when the pintle support frame is in the horizontal thruster plate it sits squarely, and efficiently transfers load to the thruster plate 32.

Below the sides 22 and cut-offs 24, the pintle support frame is of a circular cross section whose diameter decreases as one travels towards the bottom of the pintle support frame. Near the bottom of the pintle support frame 14 around its perimeter is the vertical reaction interface 20 which sits on and within reaction ring 36 when the turbine is finally located on the tower 30. To help location of pintle support frame 14 in the reaction ring 36, a capture cylinder 37 is mounted above and below FIG. 4 (A), (B), (C) shows stages of placing a turbine in a tower. Most of the parts shown in FIG. 4 are described previously in relation to FIGS. 2 and 3 and are not described again here. FIG. 4(A) shows the situation with the turbine 600 mm above its final resting place on the tower 30 with the underwater mateable connector 50 disconnected. In (B) the turbine is 150 mm above and in (C) at its resting place. In (B) the vertical reaction interface 20 is aligned with the top of capture cylinder 37 as the interface 20 is guided finally onto reastion ring 36. In (C) the load transfer blocks 28 are released to remove any gap between the stud 12/pintle support frame 14 and the horizontal thruster plate 32. The shape of the sides of the pintle support frame 14 and the cooperating aperture 34 (in FIG. 2) of the horizontal thruster 32 plate help guide the turbine to its correct position, the sides 22 and cut outs 24, prevent twisting of the turbine as it is guided into the tower. Final location is aided by the circular cross section of the lower part of the pintle support frame 14, and the capture cylinder 114.

A FIG. 5 shows the electrical connection arrangements in more detail. The connection arrangements comprise an underwater mateable connector 50, having a male part 51 to be received in a female part 52. The female part is connected to fixed cables on the tower. The connector 50 has a cylindrical slip ring body 54 aligned vertically and coaxially within the pintle support frame 14. The slip ring body has a cable penetration at the top though which the power cable 56 from the turbine and wires providing control inputs and outputs pass. The slip ring body 54 is rotatable mounted with respect to a slip ring head 58. Lugs 60 are provided on the slip ring body which interface with a drive bracket (not shown) to turn the slip ring body in response to yawing movements of the turbine. The main power output cable and other electrical connections are made to the male part of the underwater mateable connector 50. The slip ring head has a flange 62 which is bolted to the bottom of pintle support frame 14 via adapter piece 64. As the turbine yaws the slip ring body cabling therein and the slip ring will turn with it. However the slip ring head will permit that movement while maintaining the tower cable 53 take-off in place. There is no flexing of the cable in the tower and thus the risk of damage or failure is limited. Any damage as a result of flexing in the turbine cables 56 can be repaired as part of the maintenance routine when the turbine is removed from the tower 30 and taken ashore.

It can be seen that in order for the two parts 51 and 52 of the underwater mateable connector to mate successfully and electrical connection established between the tidal turbine and its tower, alignment of the tower, both horizontally and vertically must be very precise. This invention enables the location of the turbine in the tower with the required degree of precision.

Although as described in FIGS. 1 to 5 the connections to the underwater mateable connectors are made from below in the tower. In another embodiment the connections from the tower are made to one side of the wet mate connector.

Although described with reference to a gravity based structure, the invention is equally applicable to a turbine mounted on a structure that is pin piled or one that is pile mounted. In these cases the tower 30 may be directly piled into the sea bed. However, the principles of the invention are exactly the same.

It can be seen that with the arrangements of the present invention the turbines self aligns with the tower when being lowered on the tower, so that accurate electrical connection is made between constituent parts of one or more underwater mateable connectors to join the electrical cables lead from the turbines to those in the tower.

1-9. (canceled)

10. A marine turbine and tower combination in which the turbine is mountable on the tower, the turbine having a downwardly directed stud to interact with a substantially horizontal thruster plate mounted on top of the tower, the thruster plate having a central aperture, a vertical reaction ring beneath the thruster plate, wherein when the turbine is mounted on the tower, the stud extends through the aperture in the horizontal thruster plate, the stud being supported laterally by the thruster plate, and vertically by the reaction ring to enable the turbine to be mounted on the tower in a pre-determined alignment to enable the turbine to make electrical connection with electrical cables in the tower characterised in that the tower additionally comprises a capture cylinder to help to locate the stud in the reaction ring.

11. A marine turbine and tower combination according to claim 10 in which the aperture in the horizontal thruster plate has four parallel sides and the external profile of a stud where it is within the horizontal thruster plate is correspondingly shaped so that the stud is a tight fit in the horizontal thruster plate when the turbine is in position on the tower.

12. A marine turbine and tower combination according to claim 10 in s which the parallel sides are of equal lengths.

13. A marine turbine and tower combination according to claim 10 in which the angle between adjacent sides is cut-off.

14. A marine turbine and tower combination according to claim 10 in which the lower portion of the stud is circular in cross section as is the aperture of the reaction ring.

15. A marine turbine and tower combination according to claim 10 in which the stud decreases in its horizontal cross section from where is it located in the horizontal thruster plate to where it is located in the reaction ring.

16. A marine turbine and tower combination according claim 10 having guide vanes which engage the side of the stud as it is located into the reaction ring to provide further assistance in locating the turbine in the correct orientation in the thruster ring.

17. A marine turbine and tower combination according to claim 10 in which the stud comprises a pintle support frame.

18. A marine turbine and tower combination according to claim 10 having one or more underwater mateable connectors between the turbine and the tower.
